(19) United States
(12) Patent Application Publication
(10) Pub. No.: US 2015/0360787 A1
(43) Pub. Date: Dec. 17, 2015

(54) GAS TURBINE ENGINE WITH DISTRIBUTED FANS DRIVEN ON ANGLED DRIVE SHAFT

(71) Applicant: United Technologies Corporation, Hartford, CT (US)

(72) Inventors: Jesse M. Chandler, South Windsor, CT (US); Gabriel L. Suciu, Glastonbury, CT (US)

(21) Appl. No.: 14/600,235

(22) Filed: Jan. 20, 2015

Related U.S. Application Data
(60) Provisional application No. 61/989,644, filed on May 7, 2014.
(60) Provisional application No. 61/938,907, filed on Feb. 12, 2014.
(60) Provisional application No. 61/937,153, filed on Feb. 7, 2014.

(51) Int. Cl. B64D 27/12; B64D 35/02; B64C 3/00; F02C 3/10; F02C 7/36

(52) U.S. Cl. CPC B64D 27/12; F02C 3/10; F02C 7/36; B64C 3/00; B64D 35/02

(57) ABSTRACT

A gas turbine engine includes a gas generator that has at least one compressor rotor, at least one gas generator turbine rotor and a combustion section. A fan drive turbine is positioned downstream of the at least one gas generator turbine rotor. The fan drive turbine drives a driveshaft and the driveshaft engages gears to drive at least three fan rotors. The driveshaft extends away from the gas generator such that at least one of the fan rotors that is positioned remotely from the fan drive turbine on the driveshaft is spaced to be either more forward or more rearward of the fan drive turbine relative to at least one of the fan rotors positioned closer to the fan drive turbine. An aircraft is also disclosed.

### CROSS REFERENCE TO RELATED APPLICATION

This application claims priority to U.S. Provisional Application No. 61/989,644 which was filed on May 7, 2014.

### BACKGROUND OF THE INVENTION

Gas turbine engines are known and typically include a fan delivering air as bypass air into a bypass housing and further delivering air into a core engine. Air in the core engine is directed into a compressor where it is compressed. The compressed air is then delivered into a combustion section where it is mixed with fuel and ignited. Products of this combustion pass downstream over turbine rotors, driving them to rotate.

Recently, it has been proposed to increase the diameter of the fan to, in turn, increase bypass ratios, or the volume of air delivered as bypass or propulsion air compared to the volume of air delivered into the core engine. However, the ability to make this increase is somewhat limited by the packaging envelope available on an aircraft.

It has been proposed to replace a single large diameter with a plurality of fan rotors. However, the proposals for driving the plurality of fan rotors have deficiencies in general.

### SUMMARY OF THE INVENTION

In a featured embodiment, a gas turbine engine comprises a gas generator with at least one compressor rotor, at least one gas generator turbine rotor and a combustion section. A fan drive turbine is positioned downstream of at least one gas generator turbine rotor. The fan drive turbine drives a driveshaft. The driveshaft engages gears to drive at least three fan rotors. The driveshaft extends away from the gas generator such that at least one of the fan rotors that is positioned remotely from the fan drive turbine on the driveshaft is spaced to be either more forward or more rearward of the fan drive turbine relative to at least one of the fan rotors positioned closer to the fan drive turbine.

In another embodiment according to the previous embodiment, a fan shaft is driven by the driveshaft to in turn drive each of at least three fan rotors. The fan shafts rotate along axes that are substantially parallel to a rotational axis of the gas generator.

In another embodiment according to any of the previous embodiments, a single gas generator is positioned intermediate portions of the driveshaft, with portions of the driveshaft driving associated fan rotors.

In another embodiment according to any of the previous embodiments, each of the driveshaft portions drives at least four fan rotors.

In another embodiment according to any of the previous embodiments, at least one of the fan rotors positioned remotely from the fan drive turbine is spaced to be more rearward of the fan drive turbine relative to at least one of the fan rotors positioned closer to the fan drive turbine.

In another embodiment according to any of the previous embodiments, at least one of the fan rotors positioned remotely from the fan drive turbine is spaced to be more forward of the fan drive turbine relative to at least one of the fan rotors positioned closer to the fan drive turbine.

In another embodiment according to any of the previous embodiments, at least one of the fan rotors positioned remotely from the fan drive turbine is spaced to be more rearward of the fan drive turbine relative to the at least one of the fan rotors positioned closer to the fan drive turbine.

In another featured embodiment, an aircraft comprises a swept wing. A gas turbine engine comprises a gas generator with at least one compressor rotor, at least one gas generator turbine rotor and a combustion section. A fan drive turbine is positioned downstream of the at least one gas generator turbine rotor. The fan drive turbine drives a driveshaft. The driveshaft engages gears to drive at least three fan rotors. The driveshaft extends away from the gas generator such that at least one of the fan rotors that is positioned remotely from the fan drive turbine on the driveshaft is spaced to be either more forward or more rearward of the fan drive turbine relative to at least one of the fan rotors positioned closer to the fan drive turbine.

In another embodiment according to the previous embodiment, a fan shaft is driven by the driveshaft to in turn drive each of at least three fan rotors. The fan shafts rotate along axes that are substantially parallel to a rotational axis of the gas generator.

In another embodiment according to any of the previous embodiments, a single gas generator is positioned intermediate portions of the driveshaft, with portions of the driveshaft driving associated fan rotors.

In another embodiment according to any of the previous embodiments, each of the driveshaft portions drives at least four fan rotors.

In another embodiment according to any of the previous embodiments, at least one of the fan rotors positioned remotely from the fan drive turbine is spaced to be more rearward of the fan drive turbine relative to the at least one of the fan rotors positioned closer to the fan drive turbine.

In another embodiment according to any of the previous embodiments, at least one of the fan rotors positioned remotely from the fan drive turbine is spaced to be more forward of the fan drive turbine relative to at least one of the fan rotors positioned closer to the fan drive turbine.

In another embodiment according to any of the previous embodiments, there are a pair of gas generators, with each of the pair of gas turbine generators having a respective driveshaft extending away from the gas generator such that at least one of the fan rotors positioned remotely from the fan drive turbine associated with each gas generator on the associated driveshaft is spaced more forward than is at least one of the fan rotors positioned closer to the fan drive turbine.

In another embodiment according to any of the previous embodiments, there are a pair of gas generators, with each of the pair of gas turbine generators having a respective driveshaft extending away from the gas generator such that at least one of the fan rotors positioned remotely from the fan drive turbine associated with each gas generator on the associated driveshaft is spaced more rearward than is at least one of the fan rotors positioned closer to the fan drive turbine.

In another embodiment according to any of the previous embodiments, at least one of the fan rotors positioned remotely from the fan drive turbine is spaced to be more rearward of the fan drive turbine relative to the at least one of the fan rotors positioned closer to the fan drive turbine.

These and other features may be best understood from the following drawings and specification.

### BRIEF DESCRIPTION OF THE DRAWINGS

FIG. 1 schematically shows a gas turbine engine.

FIG. 2 is a front view of the FIG. 1 engine.

FIG. 3 shows a first embodiment.

FIG. 4 shows a detail.

FIG. 5 shows another embodiment.

FIG. 6 shows another embodiment.

### DETAILED DESCRIPTION

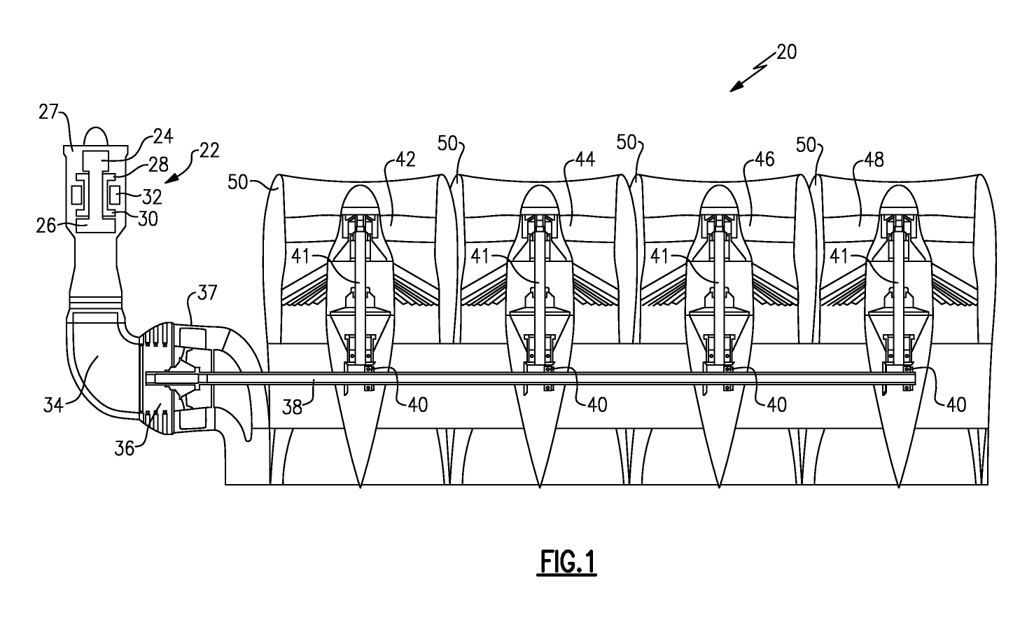

A gas turbine engine 20 is illustrated in FIG. 1 having a gas generator 22. The gas generator 22 may be a two spool gas generator having a low speed spool in which a first upstream compressor rotor 24 driven by a downstream or low pressure turbine rotor 26. A high speed spool includes a high pressure compressor rotor 28 rotating with a high pressure or upstream turbine rotor 30. A combustion section 32 is positioned intermediate rotors 28 and 30.

An exhaust duct 34 is positioned downstream of the gas generator 22 and receives products of combustion which have driven the turbine rotor 26 to rotate. These products of combustion pass across a fan drive turbine 36 mounted in a housing 37. The fan drive turbine 36 drives a shaft 38 that engages a plurality of bevel gears 40 to, in turn, drive shafts 41 associated with fan rotors 42, 44, 46 and 48. Each of the fan rotors 42, 44, 46 and 48 are mounted within separate housings 50.

By providing a single shaft 38, which drives at least four fan rotors and by utilizing a fan drive turbine 36 which is positioned downstream of the last turbine rotor 26 in a gas generator 22, this disclosure provides compact packaging, while still providing adequate drive for the fan rotors 42, 44, 46 and 48.

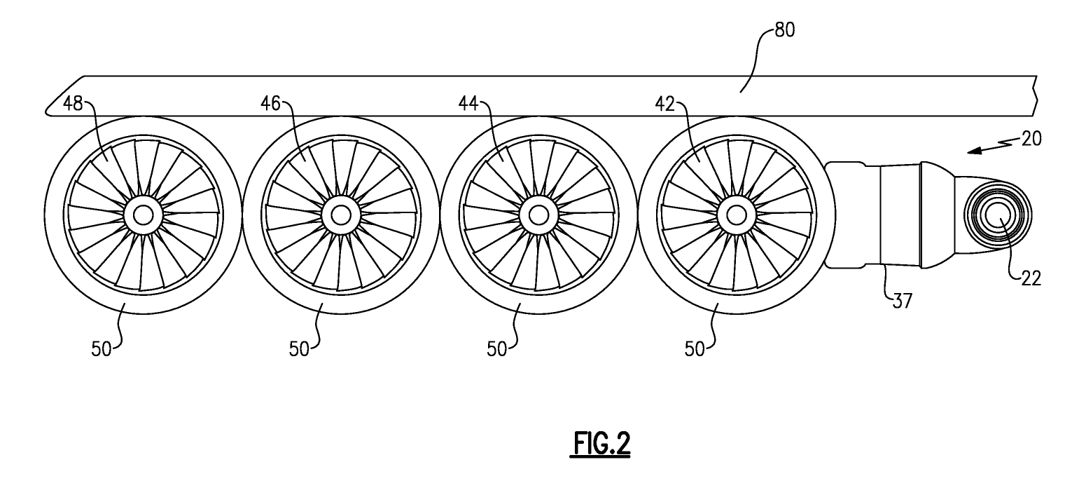

FIG. 2 is a front view of an aircraft wing 80, which may mount an engine such as engine 20. As shown, the gas generator is associated with the housing 37. The fan rotors 42, 44, 46 and 48 have diameters that are not unduly large, such that they fit within the packaging window of associated wing 80.

The basic engine as described above is disclosed in co-pending U.S. patent application Ser. No. 14/597,510, entitled “Gas Turbine Engine With Distributed Fans” and filed on even date herewith. This basic fan structure can be incorporated into a gas turbine engine arrangement having one or more gas generators, and paired sets of the distributed fan.

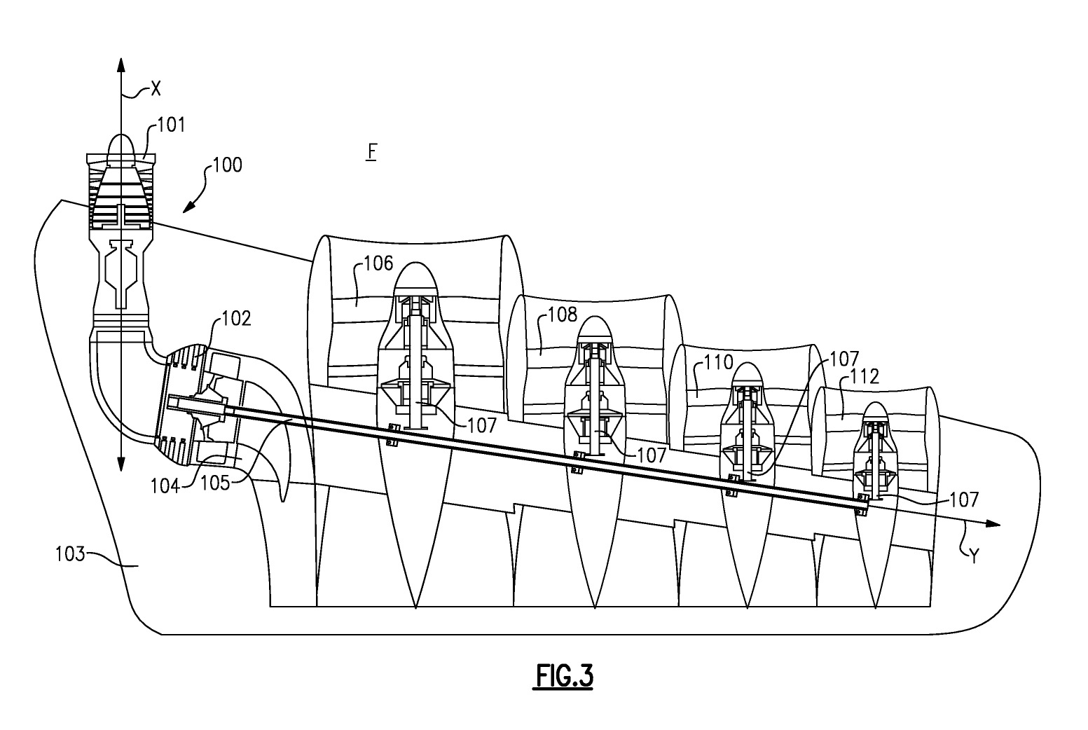

FIG. 3 shows an aircraft wing 103, which could be said to be “swept” or extending in a direction which will be rearward when mounted on an associated aircraft. The front, or forward direction, of the aircraft is shown as F. An engine 100 includes a gas generator 101 driving a fan drive turbine 102. Products of this combustion pass into an exhaust duct 104. A shaft 105 rotates about an axis Y, while the gas generator 101 rotates about an axis X. As can be appreciated, axis Y extends rearwardly away from a gas generator 101, and is not perpendicular to axis X. The shafts 107 which drive fan rotors 106, 108, 110 and 112, however, extend generally parallel to the axis X. However, due to the inclined or angled driveshaft 105, the engines are positioned to be further away from the gas generator 101 or rearward relative to the aircraft, to fit within the swept wing 103. As shown, the fan rotors 106, 108, 110, and 112 may become of smaller diameter in a direction moving outwardly away from the gas generator 101.

It could be said that the driveshaft 105 and its axis Y extend away from the gas generator 101, and such that at least one of the fan rotors 112 positioned remotely from the fan drive turbine 102 is spaced to be more rearward of the fan drive turbine 102 relative to at least one of the fan rotors 106 positioned closer to the fan drive turbine 102.

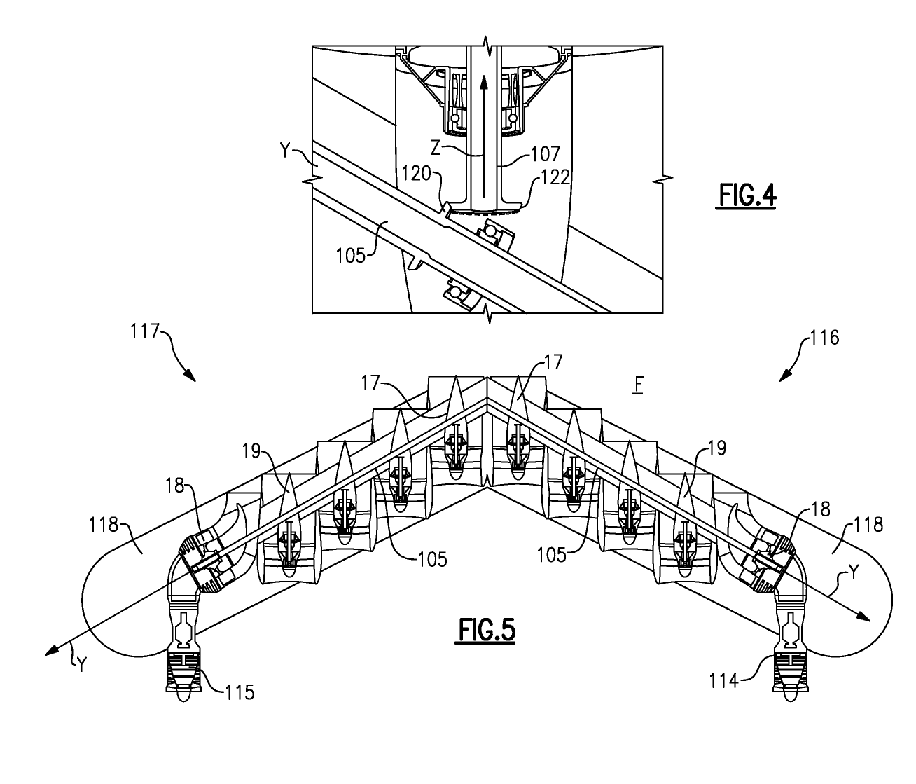

FIG. 4 shows a detail of the shaft 105, driving a gear 120 engaged with a gear 122 to drive the shaft 107. As shown, shaft 107 rotates about an axis Z, which is non-perpendicular to the axis Y, and is parallel to the axis X (see FIG. 1).

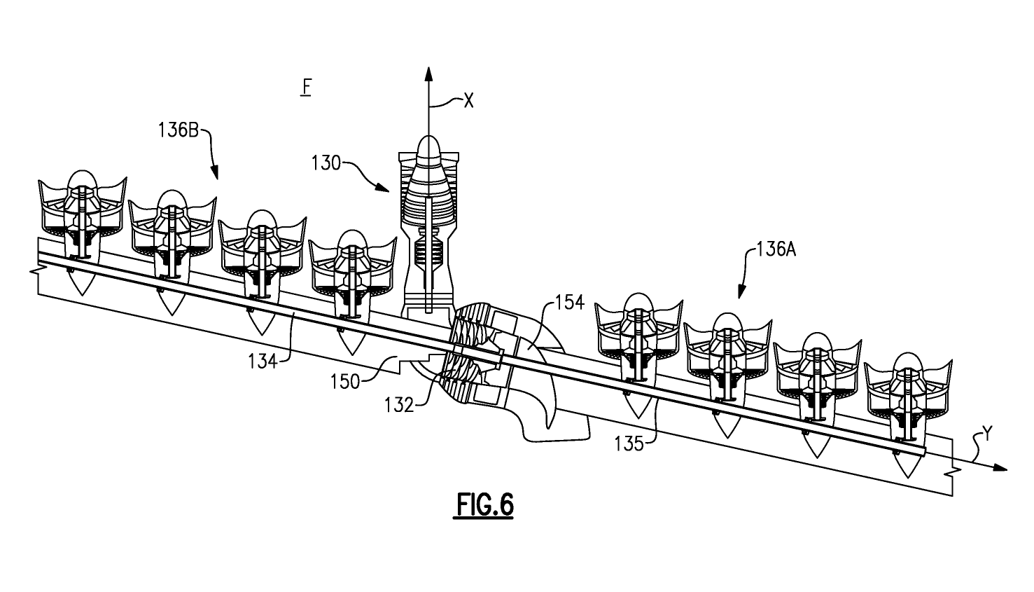

FIG. 5 shows an arrangement where two aircraft wings 118 are swept, and fan sets 117 and 116 are each similar to the engine shown in FIG. 3. The fan set 116 is driven by a gas generator 114, while gas generator 115 drives the engine set 117.

In this embodiment, it could be said that the driveshaft 105 and axes Y extend away from the gas generators 114/115, and such that at least one of the fan rotors 17 positioned remotely from the fan drive turbines 18 is spaced to be more forward of the fan drive turbine 18 relative to at least one of the fan rotors 19 positioned closer to the fan drive turbine. In fact, both of the gas turbine engines in the FIG. 5 embodiment extend such that the fan rotors more remote from the gas generators are closer to the forward position F than are the fan rotors closer to the gas generators.

FIG. 6 shows another arrangement wherein a gas generator 130 may be positioned to rotate about an axis X, and drive a fan drive turbine 132. Fan drive turbine 132 drives shaft portions 134 and 135, each of which drives a plurality of fan rotors shown at 136A/136B. In this arrangement, a shaft axis of rotation Y is non-perpendicular to the axis of rotation X. The shaft portion 134 extends forwardly to be closer to the forward end F of the associated aircraft than is shaft portion 135. In sum, the fan rotors 136A on one side of the gas generator 130 are positioned to be further away from forward end F of the associated aircraft whereas the fan rotors 136B on the opposed side are driven by shaft portion 134, and are closer to the forward end. This embodiment would typically be used along a long swept wing.

The FIG. 6 embodiment could be said to have an arrangement wherein one side 136A of the gas generator 130 has fan rotors wherein more remote fan rotors are positioned to be spaced rearwardly relative to the fan rotors that are closest to the fan drive turbine 154, and the opposed side has fan rotors 136B positioned remotely from the gas turbine generator that are more forward than the fan rotors positioned to be closer to the fan drive turbine 132.

Although various embodiments of this invention have been disclosed, a worker of ordinary skill in this art would recognize that certain modifications would come within the scope of this invention. For that reason, the following claims should be studied to determine the true scope and content of this invention.

1. A gas turbine engine comprising:
a gas generator with at least one compressor rotor, at least one gas generator turbine rotor and a combustion section;
a fan drive turbine positioned downstream of said at least one gas generator turbine rotor, said fan drive turbine for driving a driveshaft and said driveshaft engaging gears to drive at least three fan rotors; and
said driveshaft extending away from the gas generator such that at least one of said fan rotors that is positioned remotely from said fan drive turbine on said driveshaft is spaced to be either more forward or more rearward of the fan drive turbine relative to at least one of said fan rotors positioned closer to said fan drive turbine.

2. The gas turbine engine as set forth in claim 1, wherein a fan shaft is driven by said driveshaft to in turn drive each of said at least three fan rotors, and said fan shafts rotating along axes that are substantially parallel to a rotational axis of said gas generator.

3. The gas turbine engine as set forth in claim 1, wherein a single gas generator is positioned intermediate portions of said driveshaft, with portions of said driveshaft driving associated fan rotors.

4. The gas turbine engine as set forth in claim 3, wherein each of said driveshaft portions drives at least four fan rotors.

5. The gas turbine engine as set forth in claim 3, wherein said at least one of said fan rotors positioned remotely from the fan drive turbine is spaced to be more rearward of the fan drive turbine relative to said at least one of said fan rotors positioned closer to the fan drive turbine.

6. The gas turbine engine as set forth in claim 1, wherein said at least one of said fan rotors positioned remotely from the fan drive turbine is spaced to be more forward of the fan drive turbine relative to said at least one of said fan rotors positioned closer to the fan drive turbine.

7. The gas turbine engine as set forth in claim 1, wherein said at least one of said fan rotors positioned remotely from the fan drive turbine is spaced to be more rearward of the fan drive turbine relative to said at least one of said fan rotors positioned closer to the fan drive turbine.

8. An aircraft comprising:
a swept wing; and
the gas turbine engine as set forth in claim 1 connected to said swept wing.

9. The aircraft as set forth in claim 8, wherein a fan shaft is driven by said driveshaft to in turn drive each of said at least three fan rotors, and said fan shafts rotating along axes that are substantially parallel to a rotational axis of said gas generator.

10. The aircraft as set forth in claim 8, wherein a single gas generator is positioned intermediate portions of said driveshaft, with portions of said driveshaft driving associated fan rotors.

11. The aircraft as set forth in claim 10, wherein each of said driveshaft portions drives at least four fan rotors.

12. The aircraft as set forth in claim 10, wherein said at least one of said fan rotors positioned remotely from the fan drive turbine is spaced to be more rearward of the fan drive turbine relative to said at least one of said fan rotors positioned closer to the fan drive turbine.

13. The aircraft as set forth in claim 8, wherein said at least one of said fan rotors positioned remotely from the fan drive turbine is spaced to be more forward of the fan drive turbine relative to said at least one of said fan rotors positioned closer to the fan drive turbine.

14. The aircraft as set forth in claim 13, wherein there are a pair of gas generators, with each of said pair of gas turbine generators having a respective driveshaft extending away from the gas generator such that at least one of said fan rotors positioned remotely from said fan drive turbine associated with each gas generator on said associated driveshaft is spaced more forward than is at least one of the fan rotors positioned closer to the fan drive turbine.

15. The aircraft as set forth in claim 13, wherein there are a pair of gas generators, with each of said pair of gas turbine generators having a respective driveshaft extending away from the gas generator such that at least one of said fan rotors positioned remotely from said fan drive turbine associated with each gas generator on said associated driveshaft is spaced more rearward than is at least one of the fan rotors positioned closer to the fan drive turbine.

16. The aircraft as set forth in claim 8, wherein said at least one of said fan rotors positioned remotely from the fan drive turbine is spaced to be more rearward of the fan drive turbine relative to said at least one of said fan rotors positioned closer to the fan drive turbine.
